(19) United States
(12) Patent Application Publication
(10) Pub. No.: US 2014/0059035 A1
(43) Pub. Date: Feb. 27, 2014

(54) PROCESS FOR GENERATING A COMPOSITE SEARCH DOCUMENT USED IN COMPUTER-BASED INFORMATION SEARCHING

(71) Applicant: iCONECT Development, LLC, Redondo Beach, CA (US)

(72) Inventors: Cynthia J. Williams, Reston, VA (US); Ian Campbell, London (CA)

(73) Assignee: iCONECT Development, LLC, Redondo Beach, CA (US)

(21) Appl. No.: 14/010,063

(22) Filed: Aug. 26, 2013

Related U.S. Application Data
(60) Provisional application No. 61/692,854, filed on Aug. 24, 2012.

(51) Int. Cl. G06F 17/30

(52) U.S. Cl. CPC G06F 17/30011
USPC 707/711

(57) ABSTRACT

A computer-based process for generating a composite search document for use in the electronic search and retrieval of corresponding and relevant documents and/or information from an existing database or collection of electronic documents. A composite search document is created by aggregating blocks of text in an interface into a single document, which is submitted to the mathematical space of a conceptual search index or similar search engine for the purpose of performing a query and returning results.

### BACKGROUND OF THE INVENTION

This invention relates generally to computer-based information retrieval and to user accessibility to textual material stored in computer files. More particularly, this invention relates to the creation of a composite search document to be used in such computer-based information retrieval.

Increases in computer storage capacity, transmission rates and processing speed mean that many large and important collections of data are now available electronically, such as via bulletin boards, mail, and on-line texts, documents and directories. While many of the technological barriers to information access and display have been removed, the human/system interface problem of being able to locate what one really needs from the collections remains.

Methods for storing, organizing and accessing this information range from electronic analogs of familiar paper-based techniques, such as tables of contents or indices to richer associative connections that are feasible only with computers, such as hypertext and full-context addressability. While these techniques may provide retrieval benefits over the prior paper-based techniques, many advantages of electronic storage are yet unrealized.

Documents are typically stored in a database format wherein the metadata and the content of the documents are stored in the database. Most systems still require a user or provider of information to specify explicit relationships and links between data objects or text objects, thereby making the systems tedious to use or to apply to large, heterogeneous computer information files whose content may be unfamiliar to the user.

Existing technologies typically involve multiple and complex steps for such computer information retrieval. U.S. Pat. No. 4,839,853 to Deerwester et al. discloses a method for computer information retrieval using latent semantic structure. Deerwester et al. describes a process for creating a searchable database of documents and information. Deerwester et al. then describes a process for processing a user query to obtain search results from the searchable database of documents and information. Deerwester et al. does not disclose new or efficient methods for generating the search queries.

Typical conceptual search queries require an existing single document to be searched in the database in order to find similar documents. Such a search methodology limits the results that a user can obtain and requires multiple searches to be performed where a user has multiple documents to be searched in the database. Further, selection of an existing single document to represent the query may lead to erroneous results as the selected document may contain portions which are not relevant to the specific key concept being queried. Results of the query may contain documents which are similar to those irrelevant sections of the document and are referred to as false positives.

Accordingly, there is a continuing need for a process of generating search queries that more efficiently and more effectively produces search results that are useful to the searcher. There is also a need for a method whereby a user can search multiple key concepts through a common graphical interface. The present invention fulfills these needs and provides other related advantages.

### SUMMARY OF THE INVENTION

The present invention is directed to a process for computer-based retrieval of documents from a predetermined collection of electronic documents. More particularly, the present invention is directed to a process for generating a composite search document to be used in a search query for a given database of documents and/or information.

In accordance with the present invention, a set of texts is generated. This comprises creating multiple text boxes using a computerized graphical interface. Text is inputted into each text box. The inputted text may be copied from a single existing document into one or more of the text boxes. Alternatively, or in addition, the text may be copied from multiple existing documents and copied into one or more of the text boxes. Alternatively, or in addition to, user-created natural language text is inputted into one or more of the text boxes. Typically, a search concept identifier is associated with the multiple text boxes having related texts.

A combination of at least a plurality of the texts is selected. Typically, each text box is selectively selectable, such that one or more of the text boxes is selected using the graphical interface.

A digital composite search document is formed by aggregating and processing the selected texts. This is done by selecting more than one of the text boxes and aggregating and processing the texts of each of the selected text boxes.

A set of corresponding documents are retrieved from the predetermined collection of electronic documents, such as a given database of documents and/or information, utilizing a conceptual analytics index search engine to compare the composite search document to the collection of electronic documents. In a particularly preferred embodiment, the conceptual analytics index search engine comprises document management or information governance software used in connection with electronically searching documents related to a legal transaction or dispute. In one embodiment, the user may select a degree of correlation between the composite search document and corresponding documents to be retrieved from the collection of electronic documents.

A second set of corresponding documents may be retrieved from the predetermined collection of electronic documents, in accordance with the invention, by selecting a different combination of plurality of texts and forming a second digital composite search document by aggregating the selected texts and comparing the second composite search document to the collection of electronic documents using the conceptual analytics index search engine. Moreover, other texts which are related to one another but directed to a different concept or search may be assigned a search concept identifier and used collectively, or in varying combinations, to create yet other digital composite search documents to retrieve corresponding documents from the predetermined collection of electronic documents utilizing the conceptual analytics index search engine.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart depicting steps taken in accordance with the present invention;

FIG. 2 is a diagrammatic view of a computer-generated graphical interface, illustrating search concept identifiers and related information;

FIG. 3 is another diagrammatic view of a computerized graphical interface, such as a window, illustrating exemplary texts within a text box, in accordance with the present invention; and

FIG. 4 is a diagrammatic view illustrating the computerized graphical interface of FIG. 3, with the texts of selected text boxes used to form a digital composite search document, which is used by a conceptual search index engine to retrieve results of corresponding documents from a collection of electronic documents, in accordance with the present invention.

### DETAILED DESCRIPTION OF THE PREFERRED EMBODIMENTS

The present invention is directed to a process for generating a search query to be used in, for example, a conceptual search index search of a database of documents. The inventive method is best implemented in a computer program designed to facilitate the creation of a composite search document through the combination of third party text content that may be cut/pasted into a search query text box or written anecdotally. The inventive method involves the creation of a composite search document that more closely approximates the type of document and/or information that a user wants to find in a given database or collection of electronic documents.

This inventive process has applicability in any information retrieval tool and particular applicability for medical, insurance, records management, document management or legal fields as they relate to eDiscovery and similar textual search environments. A searcher can build a sample document, i.e., a virtual “smoking gun” document, by finding specific excerpts of other documents and/or free form typing of an anecdotal summary of the search and piecing them together. Those pieced together excerpts preferably comprise a summary representation of a key concept that a user may want to find one or more documents related to in the searchable database. This focused content of the compiled document would preferably retrieve the “most closely related” documents from the database for which the user is searching and will reduce the number of “false positive” documents that are retrieved in a conventional “documents like this” search.

In typical settings, such as eDiscovery in litigation, a user would have multiple terms/key concepts to be searched for in a particular database of documents and information. Under prior methods, a user would have to conduct multiple search queries for each of these multiple terms/key concepts in a quest to find a document which is representative of the key concept to be queried. Only a portion of the selected document may be exemplary of the key concept thus resulting in an overreaching search result, which depending upon the size of the database and the content of the query being searched, can consume valuable time and resources to review documents for accuracy. A single, focused search query would provide a more efficient result set from the database.

Preferably, the functionality of the instant invention is resident in a comprehensive software package providing a broad range of document review and search services. As such, the present invention is embodied in a computer software program which is executed on a computer having a processor, memory, a display such as an electronic screen, and means for inputting data and otherwise interacting with the software program, such as a touch screen, mouse, keyboard, and the like.

As discussed above, this invention has particular application in the medical, insurance, records management, document management, information governance or legal field as relates to eDiscovery or document analysis of a large quantity of documents and/or information. More preferably, this invention and the searchable database would only be accessible via authorized username and password combination through the comprehensive software package. The comprehensive software package provides a graphical user interface (GUI) that provides access to all of its features, including the instant invention. The GUI may be written in standard computer code, i.e., HTML5 or similar, and preferably provides functionality on desktop, laptop, tablet, mobile, and other computing devices.

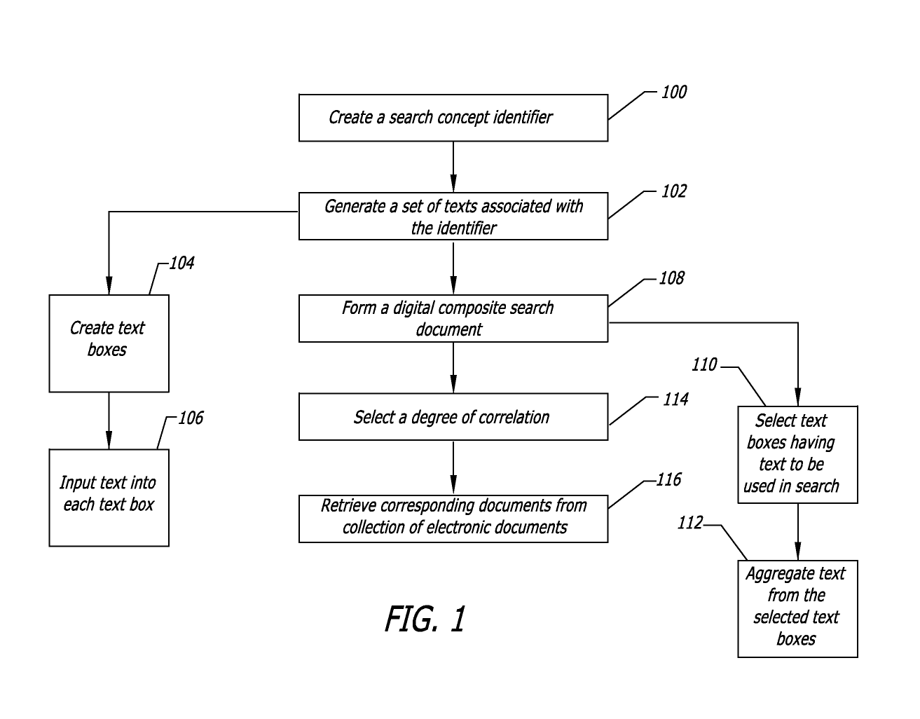

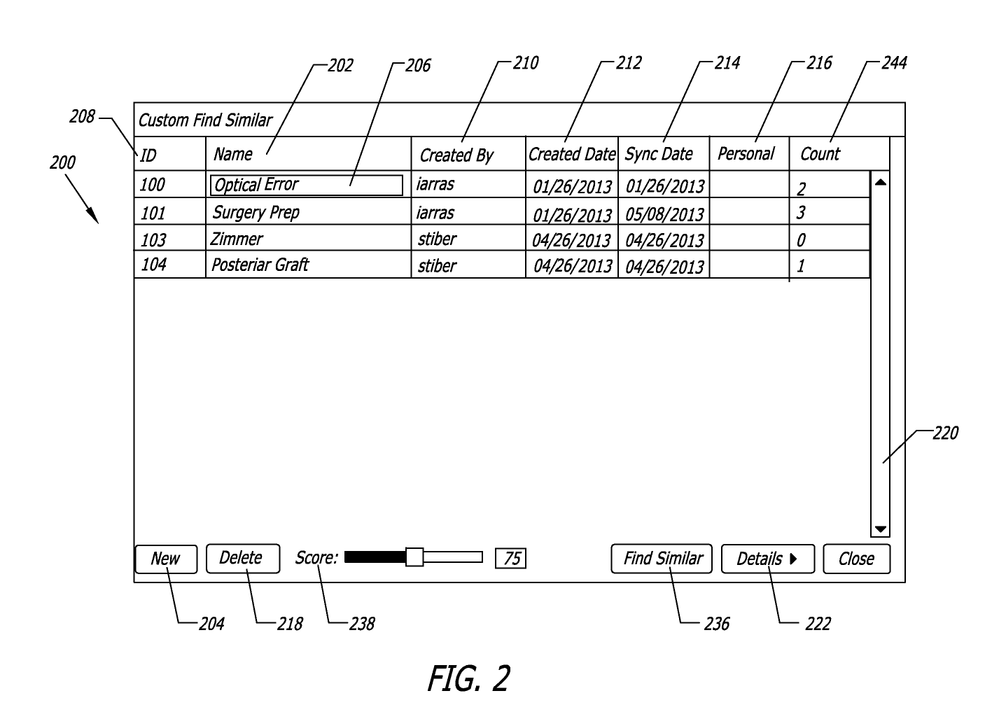

With reference now to FIGS. 1-4, and particularly FIG. 2, the invention provides a graphical user interface 200, such as the window illustrated in FIG. 2. This window interface 200 would appear on the user's electronic screen, whether it be a hand-held device, a monitor for a desktop computer, etc. As will be more fully described herein, the graphical user interface window 200 allows the one or more users to create different key concepts to be searched for, the creation of individual and distinct texts associated with each concept identifier, and a resultant composite search document to be used in a search query or process by a conceptual search index engine.

Typically, a given interface or window 200 corresponds to a specific collection of electronic documents or database. The database or collection of electronic documents may be accessible to a single user or to multiple users, or to multiple users for collaborative efforts. For example, the invention may be web-based, such as being provided on a server or on the Cloud, and accessible by multiple users either in the same location or in different geographic locations. For example, different law firms or different branches of the same law firm may be able to access the invention and work collaboratively to create composite search documents to retrieve electronic documents from the database or other collection of electronic documents being searched. Changes made through the window interface 200 are typically saved from session to session across multiple log-ins.

With reference now to FIG. 1, in accordance with the present invention, a search concept identifier is created 100. As shown in FIG. 2, each key concept to be searched is provided a name or identifier 202. A new search concept identifier may be created by clicking or otherwise selecting the “new” button 204. A name or identifier box 206 is provided wherein the user can enter the name or identification of the key search concept. The system automatically assigns the new key concept identifier an ID number 208. The system also tracks which registered user created the new key search concept identifier or name, as illustrated in column 210. The Sync Date 214 is also shown in the window 200. This may be the date when the key search concept identifier or name and file was created, but changes as the key concept identifier file is modified. For example, each time a new detail section or text box is added or modified, as will be more fully described herein, the Sync date is updated. This enables users to quickly see the status of a key concept file, particularly if the users are working in a collaborative fashion.

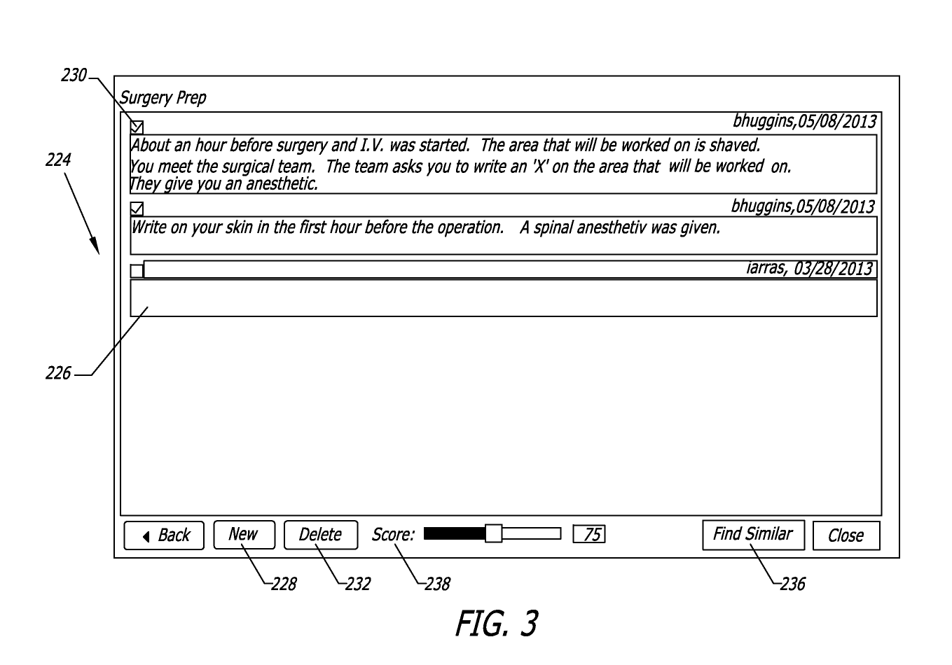

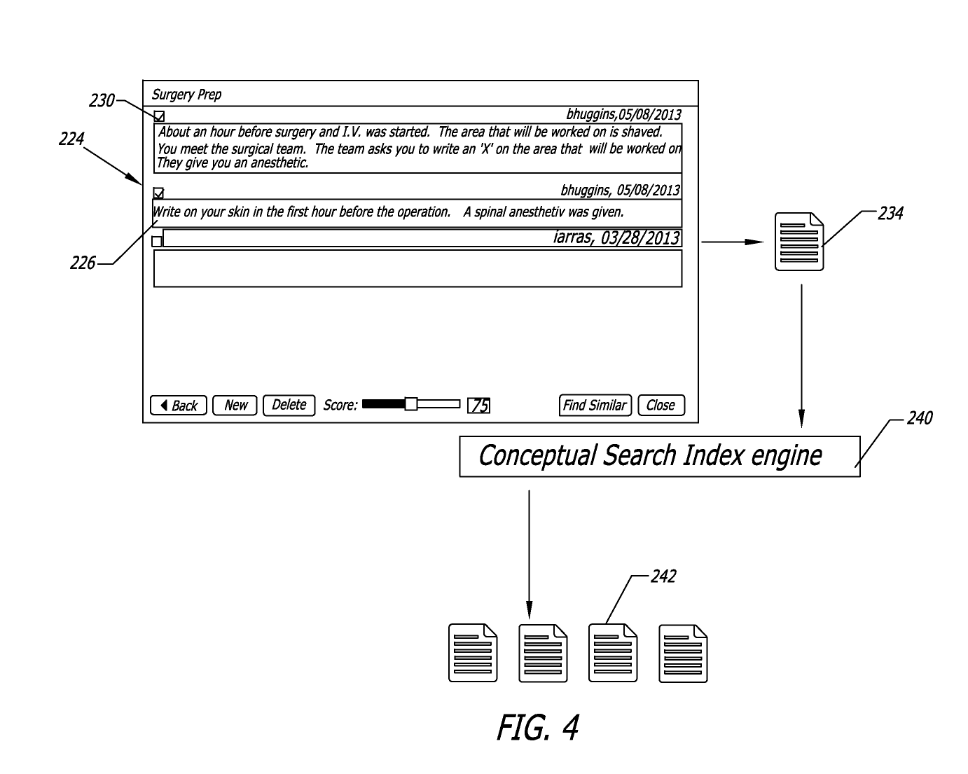

In one embodiment, all of the information contained within window 200, and the information related thereto as illustrated in FIGS. 3 and 4, are “public”, meaning that any and all registered users can view each key concept search identifier and related information. However, in some cases it is desirable to have such information remain private and privileged. For example, if two attorneys representing different parties in a matter are utilizing the present invention and accessing the same database or collection of electronic documents, each attorney or law firm will want their searches, results, etc. kept private and confidential. Thus, the users are provided the option of keeping each key concept search identifier and related information public or personal 216, as illustrated in FIG. 2, by checking a box in this section to make it personal.

Each key concept to be searched is typically represented by one key concept per line on the screen or window 200, as illustrated in FIG. 2. This key concept input list allows for a user to set up multiple key concepts in multiple and related key concept input lists. While new key concepts can be added, such as by selecting the button 204 and following the steps described above, a key concept may also be deleted, such as by selecting that key concept and depressing or otherwise selecting the “delete” button 218. A user can toggle between the multiple key concepts listed, such as by using a directional arrow, a press of a touch screen, a vertical slide or scroll bar 220 or the like.

With reference again to FIG. 1, after establishing a key concept and naming or otherwise identifying the key concept, a set of texts is generated and associated with the identifier 102. This involves the creation of text boxes 104, and the input of text into each text box 106.

With reference to FIGS. 2 and 3, the user either creates a new key concept and identifier or toggles between the multiple key concepts within the input list and selects the appropriate key concept. The details of the key concept, such as the text associated therewith, is viewed or created by selecting the appropriate key concept, or depressing another button provided in the window 200, such as the “details” button 222.

With particular reference to FIG. 3, this results in the opening of a new window 224 and graphical user interface. In this case, the “surgery prep” key concept identifier was selected. A text box, sometimes referred to herein as a detail section, 226 is either automatically generated or generated when the user depresses or otherwise selects the “new” button 228. Selecting the “new” button 228 provides an empty text search box 226 which allows for addition of an excerpt relating to the corresponding key concept.

The text excerpt can be derived from a single document or multiple documents in the collection or database. A search of this nature would be searching the database or collection for other similar documents in the same database. The text excerpts may also come from an existing external document, or multiple existing external documents. For example, the user may copy and paste into the text box 226 portions of one or more existing documents to be used in the search. Preferably, copied text excerpts from different portions of the same existing document or other documents are copied into separate text boxes 226. The texts may also come from natural language or free-form text typed into the input box 226 by the user. Each natural language or free-form text, or copied text from the one or more existing documents is saved in each text box 226 after it is entered. Each text box 226 can be selectively selected, such as by clicking selection box 230. A given text box 226 can be deleted, such as by selecting the particular text box and pressing or otherwise selecting the “delete” button 232.

With reference again to FIG. 1, a digital composite search document is then formed 108. This is done by selecting a combination of at least a plurality of the texts, such as by selecting text boxes having text to be used in the search 110. This can be done, for example, by selecting the selection box 230 of the desired text boxes to be aggregated with one another 112. All of the text within the individual distinct text boxes may be selected, or fewer than all of the text boxes selected in order to be aggregated and processed to create a digital or virtual composite search document 234. After the desired text boxes are selected, the “find similar” button 236 is depressed or otherwise selected to aggregate and process the texts within the individual selected text boxes into a digital composite search document 234, as illustrated in FIG. 4. The composite search document 234 is considered a “virtual” document in the sense that it did not previously exist and is created for the sole purpose of searching the database or collection of electronic documents.

It is contemplated by the invention that the user may be allowed to select the degree of correlation 114 between the selected texts comprising the composite search document 234 and corresponding documents retrieved from the database collection of electronic documents. This may be done, for example, by the user adjusting the score or degree of correlation, thereby adjusting the score percentage with a sliding ruler 238. As illustrated in FIGS. 2-4, the user has selected a seventy-five percent correlation between the texts within the composite search document 234 and the retrieved documents. This can be adjusted upwardly or downwardly to broaden the search results or narrow the search results. For example, the user may initially receive many more documents than desired which would require a lengthy and extensive review or which otherwise are not of the desired relevance. Thus, the user may increase the degree of correlation or score to narrow the results and obtain a more narrow and relevant set of corresponding documents.

With reference to FIG. 1, after selecting the degree of correlation 114, corresponding documents are retrieved from the collection of electronic documents 116. With reference to FIG. 4, the generated digital or virtual composite search document 234 is sent to a conceptual search index engine 240. Although the conceptual search index engine 240 may be part of the same software that embodies the present invention, more typically the conceptual search index engine is a separate software component, which may be provided by a third party. There are a variety of technologies and software platforms used to index data which the present invention can interface or otherwise be used with. For example, the software application XERA™ has the ability to communicate and interface with one or more indexes.

The digital composite search document 234, which was created, as described above, by the aggregation and processing of the texts from the selected text box to create a virtual single document to be used as essentially a seed document, is passed to the conceptual search index engine 240 and the composite search document 234 is compared to the documents within the database or collection of electronic documents to yield corresponding documents 242. This is done in accordance with the mathematical algorithms within the conceptual search index engine which is used by the user. It will be understood that the term “document” is used herein in a broad sense as is used in the industry, so as to represent documents, files, records and other electronically saved information which can be searched. The conceptual search index engine 240 provides a set of resulting documents 242, which includes similar document matches from the database or collection to the virtual composite search document which was compiled and generated as described above.

In one embodiment, the present invention is used to create the digital composite search or seed document 234. This document is then passed through an interfacing software, such as the aforementioned XERA™ product, which communicates with the conceptual search index engine. A single document's identification is sent to the third party index, and the index returns a list of document identifications and relevance rankings, which correlate to other documents in the database. This list of results is then displayed in the interfacing software, such as XERA™.

The composite search document 234 is saved and archived in the database. The composite search document 234 can be used as a query document multiple times with changes or modifications made to the virtual document 234 for each query made. That is, the composite search document 234 may be altered or modified, or a new composite search document 234 created, such as by selecting a different combination of texts from selected text boxes, as illustrated in FIG. 3. The different combination of texts, or newly added text, from the text boxes will create a different composite search document which has the potential of retrieving different search document results. The modification or creation of new text boxes, the combination of different text boxes, etc. for the modification or creation of a new composite search document can be a collaborative effort from several users of the software of the present invention, further enhancing the focus of the composite search document. This functionality allows a user or multiple users to continually modify the content, or create a new, composite search document as new text is found to be added which further focuses the composite search document 234 on the key concept. This same process can be repeated for the other key concepts which have been generated, as illustrated in FIG. 2. Further, the results can be further narrowed by further search techniques, including a Boolean search or the like.

Moreover, to assist the one or more users, a “count” 244 of the number of text boxes or detail sections 226 associated with each key concept 202 is shown on the main listing of the key concepts, as illustrated in FIG. 2. In this manner, the one or more users can quickly determine if additional text boxes or detail sections of additional texts have been added by other users.

It will be appreciated by those skilled in the art that the present invention allows a single, focused search query to be selectively created and altered in the form of a digital composite search document to be passed through existing conceptual search index engines, which has the ability to provide a more efficient result set from the database or collection of electronic documents. Various combinations of natural or free-form language queries, copies of text from existing documents, etc. can be used to modify and either broaden or narrow the search query. Furthermore, the degree of correlation between the text within the composite search document and the results achieved can be selected and changed by the user in the user's quest to find the similar documents.

Although several embodiments have been described in detail for purposes of illustration, various modifications may be made without departing from the scope and spirit of the invention. Accordingly, the invention is not to be limited, except as by the appended claims.

What is claimed is:

1. A process for computer-based retrieval of documents from a predetermined collection of electronic documents, comprising the steps of:
generating a set of texts;
selecting a combination of at least a plurality of the texts;
forming a digital composite search document by aggregating the selected texts; and
retrieving a set of corresponding documents from the predetermined collection of electronic documents utilizing a conceptual analytics index search engine to compare the composite search document to the collection of electronic documents.

2. The process of claim 1, including the step of associating related texts with a search concept identifier.

3. The process of claim 1, wherein the generating texts step comprises the steps of creating multiple text boxes using a computerized graphical interface, and inputting text into each text box.

4. The process of claim 3, wherein each text box is selectively selectable.

5. The process of claim 4, wherein the composite search document is created by selecting more than one of the text boxes and aggregating the texts of each of the selected text boxes.

6. The process of claim 1, wherein the conceptual analytics index search engine comprises document management or information governance software used in connection with electronically searching documents related to a legal transaction or dispute.

7. The process of claim 3, wherein the inputting text step comprises the step of inputting text copied from a single existing document into one or more text boxes, inputting text copied from multiple existing documents into one or more text boxes, inputting user-created natural language text into one or more text boxes, and combinations thereof.

8. The process of claim 1, including the step of retrieving a second set of corresponding documents from the predetermined collection of electronic documents by selecting a different combination of plurality of texts and forming a second digital composite search document by aggregating the selected texts and comparing the second composite search document to the collection of electronic documents using the conceptual analytics index search engine.

9. The process of claim 1, including the step of selecting a degree of correlation between the composite search document and corresponding documents retrieved from the collection of electronic documents.

10. A process for generating a composite search document for computer-based retrieval of corresponding documents from a predetermined collection of electronic documents, comprising the steps of:
creating multiple text boxes using a graphical interface, wherein each text box is selectively selectable;
inputting text into each text box;
selecting more than one of the text boxes using the graphical interface; and
forming a digital composite search document by aggregating the texts of the selected text boxes.

11. The process of claim 10, including the step of associating a search concept identifier with the multiple text boxes.

12. The process of claim 10, wherein the inputting text step comprises the step of inputting text copied from a single existing document into one or more text boxes, inputting text copied from multiple existing documents into one or more text boxes, inputting user-created natural language text into one or more text boxes, and combinations thereof.
